(19) United States
(12) Patent Application Publication
(10) Pub. No.: US 2024/0430914 A1
(43) Pub. Date: Dec. 26, 2024

(54) BLE Audio Broadcasting Method, Device and System

(71) Applicant: Zgmicro Wuxi Corporation, Wuxi Jiangsu (CN)

(72) Inventors: Bin XU, Wuxi (CN); David Xiaodong Yang, Wuxi (CN)

(73) Assignee: Zgmicro Wuxi Corporation, Wuxi (CN)

(21) Appl. No.: 18/586,457

(22) Filed: Feb. 24, 2024

(30) Foreign Application Priority Data
Jun. 20, 2023 (CN) 2023107347835.5

(51) Int. Cl. H04W 72/30; H04L 5/00; H04W 72/0446

(52) U.S. Cl. CPC H04W 72/30; H04L 5/0048; H04W 72/0446

(57) ABSTRACT

BLE audio broadcasting methods, and devices are described. The BLE audio broadcasting method applied to one slave device of a BLE audio broadcasting system comprises: performing a BLE audio data broadcast communication with the master device in a plurality of consecutive isochronous intervals by the slave device; and performing a periodic advertising communication with reverse control with the master device based on a periodic advertising channel within one or more target isochronous intervals being one or more of the consecutive isochronous intervals. The periodic advertising communication with reverse control comprises: determining whether the present slave device is a target slave device that requires a reverse communication; and transmitting a reverse communication data based on the periodic advertising channel in one or more shared reverse control time slots in the one or more target isochronous intervals without need for the master device to allocate an exclusive time slot for the present salve device when the present slave device is determined to be the target slave device, wherein the one or more shared reverse control time slots can be occupied by any one of the slave devices when transmitting the reverse communication data. The present invention can realize reverse control and bi-directional communication of point-to-multipoint audio broadcast communication when information of the slave devices is uncertain, thereby enhancing controllability of the BLE audio broadcasting system.

### CROSS-REFERENCE OF RELATED APPLICATIONS

The present invention claims priority of Chinese Patent Application No. 2023107347835 filed in China on Jun. 20, 2023, the entire contents of which are incorporated herein by reference.

### BACKGROUND OF THE INVENTION

### Field of the Invention

The present invention relates to the field of wireless communication, and in particular to a Bluetooth Low Energy or BLE audio broadcasting method, a BLE audio broadcasting device, and a BLE audio broadcasting system.

### Description of the Related Art

Wireless audio technology has been widely loved by people due to unrestricted talk and audio enjoyment brought by the wireless audio technology. In particular, Bluetooth Low Energy (BLE) audio technology, which adopts Isochronous Channels protocols, namely, a Connected Isochronous Stream (CIS) link and a Connected Isochronous Group (CIG) protocol consisting of a plurality of CIS links for point-to-point communication, and a Broadcast Isochronous Stream (BIS) link and a Broadcast Isochronous Group (BIG) protocol consisting of a plurality of BIS links for point-to-multipoint communication, brings people lower power consumption, lower cost, higher quality, lower latency, and richer wireless audio service. For example, an Auracast function for BLE broadcast released newly by Bluetooth SIG is a wireless music sharing application based on the BIG protocol and a public broadcast profile (PBP) protocol.

Main application scenarios of the Auracast function are public places such as airports, stations, shopping malls, cafes, and muted TVs. Anyone in the public places can use their own Bluetooth audio device to access an Auracast system and listen to music at any time. In these application scenarios, an Auracast receiving device may be a wireless earphone or wireless hearing aid for any audience. It does not require the Auracast receiving device to feedback status information to an Auracast transmitting device, and it does not require the Auracast receiving device to reverse control the Auracast transmitting device and indirectly control the other Auracast receiving devices. The Auracast transmitting device also cannot receive any information from the Auracast receiving device. Therefore, PBP and BIG do not support point-to-multipoint reverse communication or bidirectional communication, which results in the BIG-based Auracast or PBP not being able to be applied to music sharing party scenarios or multi-room distributed speaker scenarios that require interactive control functionality.

Although a Bluetooth specification version 5.4 has added a Periodic Advertising with Response (PAWR) protocol to support point-to-multipoint bidirectional communication link, but the main application scenario of PAWR is Electronic Shelf Label (ESL). In order to meet the specific needs of ESL for ultra-low power consumption and ultra-long standby, PAWR configures an exclusive reverse communication time slot for each slave device (ESL), and the slave device only needs to send information to the master device in its own exclusive reverse communication time slot. Therefore, the master device of PAWR must predetermine the device information and the number of all slave devices in the PAWR system in order to allocate the exclusive communication time slot for each slave device. The slave devices of PAWR can only respond to the master device in its own exclusive communication time slots according to the master's request if they are registered in the master device in advance and are addressed by the master device. Obviously, this method cannot be applied to application scenarios such as Auracast, which are not convenient to register the slave devices and count the number of slave devices in advance.

Therefore, the traditional BLE audio broadcasting technology does not solve the problem of how to realize reverse control and bi-directional communication of point-to-multipoint when information of the slave devices is uncertain.

### SUMMARY

A purpose of the present invention is to provide a BLE audio broadcasting method and a BLE audio broadcasting device, which can improve controllability of a BLE audio broadcasting communication system.

To achieve the purpose, according to one aspect of the present invention, a BLE audio broadcasting method is provided. The BLE audio broadcasting method is applied to one slave device of a BLE audio broadcasting system comprising a master device and one or more slave devices. The BLE audio broadcasting method comprises: performing a BLE audio data broadcast communication with the master device in a plurality of consecutive isochronous intervals by the slave device; and performing a periodic advertising communication with reverse control with the master device based on a periodic advertising channel within one or more target isochronous intervals being one or more of the consecutive isochronous intervals. The periodic advertising communication with reverse control comprises: determining whether the present slave device is a target slave device that requires a reverse communication; and transmitting a reverse communication data based on the periodic advertising channel in one or more shared reverse control time slots in the one or more target isochronous intervals without need for the master device to allocate an exclusive time slot for the present salve device when the present slave device is determined to be the target slave device, wherein the one or more shared reverse control time slots can be occupied by any one of the slave devices when transmitting the reverse communication data.

According to another aspect of the present invention, a BLE audio broadcasting method is provided. The BLE audio broadcasting method is applied to a master device of a BLE audio broadcasting system comprising the master device and one or more slave devices. The BLE audio broadcasting method comprises: performing a BLE audio data broadcast communication with the slave devices in a plurality of consecutive isochronous intervals by the master device; and performing a periodic advertising communication with reverse control with the slave devices based on a periodic advertising channel within one or more target isochronous intervals being one or more of the consecutive isochronous intervals. The periodic advertising communication with reverse control comprises: receiving a reverse communication data transmitted by a target slave device based on a periodic advertising channel in one or more shared reverse control time slots in the one or more target isochronous intervals without need for the master device to allocate an exclusive time slot for the target salve device, wherein the target slave device is one slave device that requires a reverse communication, the one or more shared reverse control time slots can be occupied by any one of the slave devices when transmitting the reverse communication data.

According to still another aspect of the present invention, a Bluetooth audio broadcasting device used as a slave device is provided. The Bluetooth audio broadcasting device is configured for: performing a BLE audio data broadcast communication with a master device of a BLE audio broadcasting system in a plurality of consecutive isochronous intervals; performing a periodic advertising communication with reverse control with the master device based on a periodic advertising channel within one or more target isochronous intervals being one or more of the consecutive isochronous intervals. The periodic advertising communication with reverse control comprises: determining whether the present slave device is a target slave device that requires a reverse communication; and transmitting a reverse communication data based on the periodic advertising channel in one or more shared reverse control time slots in the one or more target isochronous intervals without need for the master device to allocate an exclusive time slot for the present salve device when the present slave device is determined to be the target slave device, wherein the one or more shared reverse control time slots can be occupied by any one of the slave devices when transmitting the reverse communication data.

In the present invention, while the master device and the slave devices of the BLE audio broadcasting system perform the BLE audio data broadcast communication, the master device and the slave devices also performs the periodic advertising communication with reverse control based on a periodic advertising channel within one or more target isochronous intervals. The one or more target isochronous intervals are one or more of the consecutive isochronous intervals. One or more shared reverse control time slots are configured within the target isochronous intervals. The shared reverse control time slots can be occupied by any one of the slave devices when transmitting the reverse communication data. During the periodic advertising communication with reverse control, the master device does not need to allocate the exclusive time slot for the target slave device, and all the target slave devices that require the reverse communication can occupy the shared reverse control time slots in the target isochronous intervals in order to send the reverse communication data. Thus, the present invention can realize reverse control and bi-directional communication of point-to-multipoint audio broadcast communication when information of the slave devices is uncertain, thereby enhancing controllability of the BLE audio broadcasting system.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings wherein:

FIG. 1 is a schematic diagram of a BLE audio broadcasting system according to one embodiment of the present invention;

FIG. 2 is a schematic diagram of a time slot structure of the BLE audio broadcasting system according to one embodiment of the present invention;

FIG. 3 is a flow diagram of a BLE audio broadcasting method applied to a master device of the BLE audio broadcasting system according to one embodiment of the present invention;

FIG. 4 is a flow diagram of a BLE audio broadcasting method applied to a slave device of the BLE audio broadcasting system according to one embodiment of the present invention;

FIG. 5 is a schematic format diagram of an extended header of a periodic advertising packet or a reverse communication packet according to one embodiment of the present invention;

FIG. 6 is a schematic format diagram of extended header Flag fields in the extended header according to one embodiment of the present invention;

FIG. 7 is a schematic format diagram of Reverse Control Flags according to one embodiment of the present invention; and

FIG. 8 is a schematic structure diagram of an electronic device according to one embodiment of the present invention.

### DETAILED DESCRIPTION OF THE PREFERRED EMBODIMENTS

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

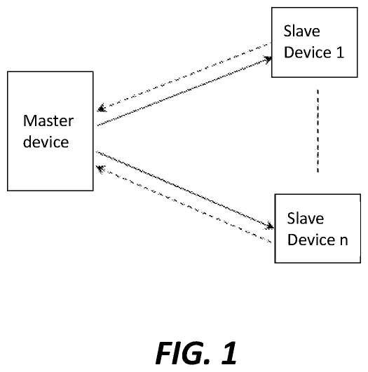

FIG. 1 is a schematic diagram of a BLE audio broadcasting system according to one embodiment of the present invention. The BLE audio broadcasting system comprises a master device and one or more slave devices. The master device and the slave devices are configured for performing a BLE audio data broadcast communication in a plurality of consecutive isochronous intervals. The BLE audio data broadcast communication can be realized using a Bluetooth broadcast-based isochronous channels protocol. Based on BLE broadcast isochronous streams (BIS), it can be realized that data broadcasted by one data source is received by a plurality of data receivers. A communication time of BIS is divided into a plurality of isochronous intervals (ISO Interval). The data source encapsulates the audio data into individual BIS packets, which are broadcasted in one or more broadcast time slots of each isochronous interval based on the BLE isochronous channels. After synchronizing with the data source, the data receiver can scan the BLE isochronous channels in the broadcast time slots to receive the BIS packets broadcast by the data source and convert them into audio for playback.

A role of the master device in the BLE broadcast communication is the data source and a role of the slave device is the data receiver. The master device may be implemented as any of following electronic devices: a cellular phone, a portable game console, a portable media playback device, a personal computer, an in-vehicle media playback device, and the like. The slave devices may be any type of audio output device for converting the audio data into audio, such as speakers, in-ear headphones, headphones, speakers, and the like. It can be understood that in some application scenarios, the master device may change its role and be used as the slave device, and the slave device may also change its role and be used as the master device.

The number of the slave devices may be one or more. Indeed, the slave devices may be any device receiving isochronous streams within a broadcast range, and their number can also dynamically change. The present invention does not limit the number of the slave devices. The data source in the BLE broadcast communication can also perform a periodic advertising (PA) communication. ACAD (Additional Controller Advertising Data) fields of the periodic advertising can carry BIG information (broadcast isochronous group synchronization information, BIGInfo). The data receiver can receive the periodic broadcast and get the BIGInfo, the data receiver can synchronize to the BIG according to the BIGInfo to get the audio broadcast data on the BIG, i.e., the BIS packet. Main parameters of the BIGInfo can contain parameters specified by the Bluetooth protocol, such as ISO Interval, BIS Num, NSE, BN, IRC, SDU Size, etc., which are not described herein.

In one embodiment, the master device and slave device also perform a periodic advertising communication with reverse control (PAWRC) based on a periodic advertising channel within one or more target isochronous intervals. The one or more target isochronous intervals are one or more of the consecutive isochronous intervals. One or more shared reverse control time slots are configured within the one or more target isochronous intervals. The one or more shared reverse control time slots can be occupied by any one of the slave devices when transmitting reverse communication data.

In one specific embodiment, a periodical advertising time slot may also be configured within one target isochronous interval. When the BLE broadcasting system performs the periodic advertising communication with reverse control, the target slave device, of the slave devices, that requires a reverse communication is configured to transmit the reverse communication data in the one or more shared reverse control time slots without requiring the master device to allocate an exclusive time slot for the target slave device. The master device is configured to receive in the one or more shared reverse control time slots to obtain the reverse communication data.

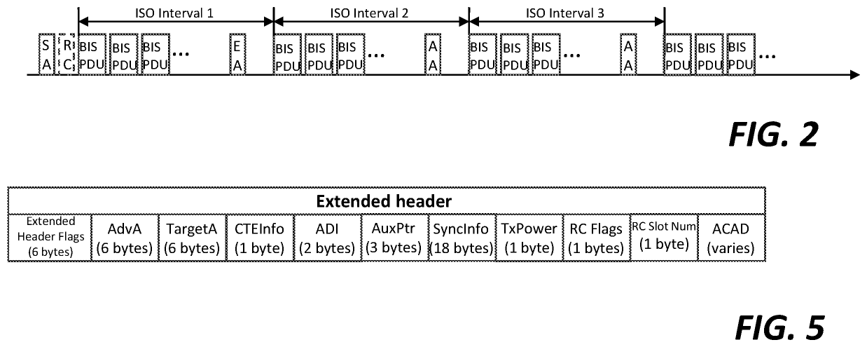

FIG. 2 is a schematic diagram of a time slot structure of the BLE audio broadcasting system according to one embodiment of the present invention. Three consecutive isochronous intervals ISO Interval1, ISO Interval2 and ISO Interval3 are shown in FIG. 2. ISO Interval2 is the target isochronous interval, a box labeled SA represents one periodic advertising time slot, a box labeled RC represents one shared reverse control time slot, and a box labeled BIS PDU represents one broadcast time slot.

It can be understood that the target isochronous interval may be some or all of the isochronous intervals. The number of shared reverse control time slots can be one or more. In one specific embodiment, a time domain position of each target isochronous interval in the communication time, as well as the time domain positions of the periodic advertising time slot and the shared reverse control time slot in the target isochronous interval can be pre-determined, so that these time domain positions can be known after any slave device is synchronized to the BLE broadcasting system. Specifically, the periodic advertising time slot has a predetermined time domain position within the target time interval. A first predetermined time period is spaced between a termination time point of the periodic advertising time slot and a start time point of the shared reverse control time slot adjacent to the periodic advertising time slot in the time domain. A second predetermined time period is spaced between a termination time point of a previous shared reverse control time slot and a start time point of a subsequent shared reverse control time slot in two adjacent shared reverse control time slots when there is a plurality of shared reverse control time slots within one target isochronous interval. A third predetermined time period is spaced between two adjacent target isochronous time slots in the time domain.

In one embodiment, the first predetermined time period and the second predetermined time period are configured to be as short as possible, which can reduce time slot resource occupied by the periodical advertising communication, accelerate response speed of the reverse communication, and improve transmission efficiency. In one preferred embodiment, the first predetermined time period and the second predetermined time period can both be set as a minimum event space T_MSS or a minimum data inter-frame space T_IFS as specified by the Bluetooth protocol. According to the current Bluetooth protocol, both T_MSS and T_IFS are 150 us.

In one specific embodiment, the target isochronous interval may be set with reference to a periodic advertising method of the traditional BLE broadcast communication. It is also possible to select a portion from the isochronous intervals as the target isochronous interval after the reverse communication function has been allowed. The details may be set according to the application scenario. In one preferred embodiment, the third predetermined time period is set as an integer multiple of the isochronous interval.

In one specific embodiment, the master device broadcasts a periodic advertising packet within one periodic advertising time slot SA and the target slave device transmits a reverse communication packet within one shared reverse control time slot RC. The periodic advertising packet or the reverse communication packet may comprise one or more of following flag fields, thereby carrying associated communication data.

A first flag field (RC Slot Num) is configured for the master device to indicate a number N of shared reverse control time slots, and N is a positive integer greater than or equal to 1. A second flag field (RC flags) is configured for the master device to indicate a reverse communication enabling instruction which indicates that one or more functions of reverse control or response are allowed/prohibited, or, for the slave device to indicate a reverse communication indication message which indicates that the reverse communication data for one or more functions is carried in the reverse communication packet.

A third flag field (AdvA) is configured for indicating an address of the master device. A fourth flag field (TargetA) is configured for the master device to indicate a target slave device designation instruction, or, for the target slave device to indicate an address of this device. In one specific embodiment, the master device represents the target slave device designation instruction by indicating the address of the target slave device.

A fifth flag field (CTEInfo) is configured for indicating a constant tone extension information. A sixth flag field (ADI) is configured for indicating an advertising data information. A seventh flag field (AuxPtr) is configured for indicating an auxiliary advertising pointer. An eighth flag field (SyncInfo) is configured for indicating a synchronization information. A ninth flag field (TxPower) is configured for indicating a transmit power. A tenth flag field (ACAD) is configured for indicating an additional controller advertising data (ACAD).

In one specific embodiment, bits in the second flag field RC flags correspond to the one or more functions, respectively. By setting values of the bits in the second flag field RC flags, the master device can transmit enable instructions for allowing and prohibiting various functions, and the slave device can transmit the reverse communication indication message corresponding to various functions.

It is to be understood that the above-described flag fields may be set in the packet header of the periodic advertising packet or the reverse communication packet or in the advertising data of the periodic advertising packet or the reverse communication packet. The BLE audio broadcasting method according to one embodiment of the present invention will be described in detail hereafter in conjunction with the master device and the slave devices in the BLE audio broadcasting system, respectively.

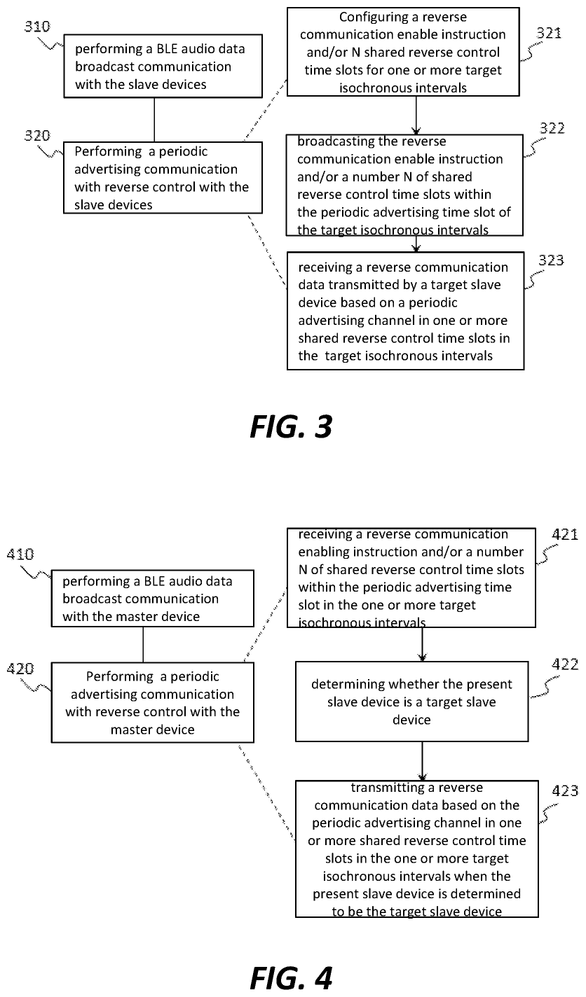

FIG. 3 is a flow diagram of a BLE audio broadcasting method applied to a master device of the BLE audio broadcasting system according to one embodiment of the present invention. The BLE audio broadcasting system comprises the master device and one or more slave devices. At 301, the master device performs a BLE audio data broadcast communication with the slave devices in a plurality of consecutive isochronous intervals.

At 302, the master device also performs a periodic advertising communication with reverse control with the slave devices based on a periodic advertising channel in one or more target isochronous intervals. The periodic advertising communication specifically comprises: the master device receives a reverse communication data transmitted by a target slave device based on a periodic advertising channel in one or more shared reverse control time slots in the one or more target isochronous intervals without need for the master device to allocate an exclusive time slot for each target salve device at 323.

The target slave device is one slave device among the slave devices that requires a reverse communication. The one or more target isochronous intervals are one or more of the consecutive isochronous intervals. One or more shared reverse control time slots are configured within one target isochronous interval. The one or more shared reverse control time slots can be occupied by any one of the slave devices when transmitting the reverse communication data.

In one embodiment, the master device does not need to individually control a process of the reverse communication of each slave device. Therefore, the slave devices for the reverse communication do not need to be pre-registered in the master device. The master device does not need to count the number of slave devices for the purpose of reverse communication, and the master device does not need to separately allocate the exclusive time slot, that can be used by only one slave device, for each slave device, thereby satisfying various music sharing scenarios, especially reverse interaction functions in application scenarios that do not pre-determine information of the slave devices, saving the time slot resources and reducing the power consumption of the master device.

A periodic advertising time slot is further configured within one target isochronous interval. The periodical advertising communication may further comprise some operations for the master device to configure and send relevant parameters for the reverse communication.

In one specific embodiment, as shown in FIG. 3, the master device configures a reverse communication enabling instruction at 321. The reverse communication enabling instruction is configured to indicate that one or more functions of reverse control or response are allowed/prohibited. As shown in FIG. 3, the master device broadcasts the reverse communication enabling instruction within the periodic advertising time slot in the one or more target isochronous intervals at 322.

The one or more functions may comprise one or more of lighting pattern control, volume control, media control, transmit power control, version information, and power off control. Of course, other functions may also be comprised according to specific application scenarios, which are not listed herein one by one. In a preferred embodiment, the master device can indicate enabling statuses of the more functions of reverse control or response at the same time by means of the reverse communication enabling instruction.

The master device may configure the reverse communication enabling instruction based on an external input instruction. In one specific embodiment, a user may input the reverse communication enabling instruction to the master device via a user interface on the master device. For example, if the user does not want the slave devices to change the lighting pattern of the BLE audio broadcasting system in the current time period, the user can give one reverse communication instruction to the master device to prohibit the lighting pattern control through a key on the master device, and the master device sends the reverse communication enabling instruction to inform all the slave devices, thus stopping the function of adjusting the lighting pattern in reverse by the slave device.

The master device may also automatically configure the reverse communication enabling instruction according to the system operation. For example, periodically allowing/prohibiting the reverse communication, allowing/prohibiting the reverse communication when certain information errors are found, etc.

In one specific embodiment, the reverse communication enabling instruction may also be issued with respect to one or some slave devices. For example, a target slave device designation instruction may be configured and transmitted at the same time as the reverse communication enabling instruction is sent, so as to achieve a control effect of the master device actively selecting the target slave device for the reverse communication. As a preferred embodiment, the target slave device designation instruction may be information such as a device number, a Bluetooth address, and the like of the slave device.

In one specific embodiment, as shown FIG. 2, the master device configures N shared reverse control time slots for the target isochronous intervals in 321; and the master device broadcasts a number N of the shared reverse control time slots within the periodic advertising time slot of the target isochronous intervals. N is a positive integer greater than or equal to 1.

The master device can improve communication quality and transmission efficiency of the reverse communication in different application scenarios and communication environments by flexibly adjusting the number N of shared reverse control time slots. For example, in general, only 1 shared reverse control time slot can be configured in one target isochronous interval, which can save time slot resources. In cases where a larger number of slave devices is expected, faster reverse information interaction is required, the communication environment is highly disturbed, etc., a plurality of shared reverse control time slots may be configured in each target isochronous interval, so that there is an increased opportunity for the target slave devices to send the reverse communication data, thereby improving the transmission efficiency and the communication quality of the reverse communication.

The master device may receive within each shared reverse control time slot, or may receive within some of the shared reverse control time slots to further save power consumption. In one specific embodiment, the master device receives the reverse communication data sent by the target slave device in each shared reverse control time slot in each target isochronous interval during the reverse communication that allows one or more functions.

FIG. 4 is a flow diagram of a BLE audio broadcasting method applied to a slave device of the BLE audio broadcasting system according to one embodiment of the present invention. The BLE audio broadcasting system comprises a master device and one or more slave devices. The slave devices and the master device perform a BLE audio data broadcast communication in a plurality of consecutive isochronous intervals at 410. The slave devices and the master device perform a periodic advertising communication with reverse control based on a periodic advertising channel in one or more target isochronous intervals at 420. The periodic advertising communication with reverse control comprises: the slave device determines whether the present slave device is a target slave device that requires a reverse communication at 422; the slave device transmits a reverse communication data based on the periodic advertising channel in one or more shared reverse control time slots in the one or more target isochronous intervals without need for the master device to allocate an exclusive time slot for the present salve device when the present slave device is determined to be the target slave device at 423.

The one or more target isochronous intervals are one or more of the consecutive isochronous intervals. One or more shared reverse control time slots are configured within one target isochronous interval. The shared reverse control time slots may be occupied by any one of the slave devices when transmitting the reverse communication data.

In one embodiment, the master device does not need to individually control a process of the reverse communication of each slave device. Therefore, the slave devices for the reverse communication do not need to be pre-registered in the master device and wait for the master device to allocate the exclusive time slot that can only be used by itself, but can decide on its own to use any time slot in the shared reverse control time slots for transmitting the reverse communication data. This allows the slave device to have more autonomy in the reverse communication, thereby satisfying the needs for reverse interaction function in various music sharing scenarios, especially application scenarios that do not pre-determine information of the slave devices, and providing a better user experience.

In one specific embodiment, the slave device determines whether the present slave device is the target slave device which requires the reverse communication based on an externally inputted reverse control instruction. The slave device may be configured with a user interface, such as a keypad, a touch screen, a voice recognition system, etc., such that a user of the slave device may enter the reverse control instruction via the user interface to control the slave device to enter a reverse communication state. For example, the user may send the reverse communication data for increasing/decreasing a volume of the BLE audio broadcasting system to the master device by pressing volume increasing/decreasing buttons on the slave device, thereby realizing the function of the slave device controlling the volume of the entire BLE audio broadcasting system in reverse via the master device.

In one specific embodiment, at 422, the slave device receives a target slave device designation instruction broadcasted by the master device within the periodic advertising time slot of the one or more target isochronous intervals, and determines whether the present slave device is the target slave device that requires the reverse communication based on the target slave device designation instruction. As a preferred embodiment, the target slave device designation instruction may be information such as a device number, a Bluetooth address, and the like of the slave device.

In one specific embodiment, a periodic advertising time slot is configured within one target isochronous interval. Referring to FIG. 4, the periodical advertising communication with reverse control further comprises: the slave device receives a reverse communication enabling instruction broadcasted by the master device within the periodic advertising time slot in the target isochronous intervals at 421, wherein the reverse communication enabling instruction is configured to indicate that one or more functions of reverse control or response are allowed/prohibited; the slave device determines whether to transmit the reverse communication data based on the reverse communication enabling instruction when the present slave device is determined to be the target slave device. When the reverse communication enabling instruction indicates that one certain function of reverse control or response is prohibited, even if it determines that the present slave device is the target slave device, the slave device does not send the reverse communication data for the prohibited function.

In one specific embodiment, a periodic advertising time slot is configured within one target isochronous interval. Referring to FIG. 4, the periodical advertising communication with reverse control further comprises: the slave device receives a number N of shared reverse control time slots broadcasted by the master device within the periodic advertising time slot in the target isochronous intervals, wherein N is a positive integer greater than or equal to 1; and determines a time domain position of each shared reverse control time slot within the target isochronous interval based on the number N of shared reverse control time slots. With reference to the foregoing, the master device may flexibly adjust the number N of shared reverse control time slots, and the slave device may determine the time domain position of each shared reverse control time slot within each target isochronous interval based on the received number N of shared reverse control time slots, as well as parameters such as the time domain position of the periodical advertising time slot in the target isochronous interval, an interval between the shared reverse control time slot and the periodical advertising time slot, and an interval between the two adjacent shared reverse control time slots.

In one specific embodiment, the periodic advertising communication with reverse control further comprises that the slave device selects one or more target shared reverse control time slots among the shared reverse control time slots in the one or more target isochronous intervals based on a predetermined selection mechanism without the need for the master device to allocate the exclusive time slot for the present slave device, wherein the target shared reverse control time slots are configured for the target slave device to transmit the reverse communication data.

It can be understood that the slave device can select and determine the target shared reverse control time slots before the slave device is determined to be the target slave device. It is also possible to select and determine the target shared reverse control time slots after the slave device is determined to be the target slave device. In one specific embodiment, the predetermined selection mechanism comprises one or more of the following selection mechanisms, which may be used independently or in combination with each other. It can be understood that more specific selection mechanisms can be set according to specific application scenarios.

The first mechanism is to select each shared reverse control time slot in one target isochronous interval as the one or more target shared reverse control time slots. This selection mechanism can fully utilize all shared reverse control time slots to speed up the response speed of the reverse communication of the slave device.

The second mechanism is to select, based on a randomly generated delay duration, corresponding shared reverse control time slot after delaying the delay duration as the one or more target shared reverse control time slots.

This selection mechanism helps the slave devices to reduce mutual interference in the reverse communication. When two slave devices in the system are simultaneously determined to be the target slave devices, each of the two slave devices staggers the target shared reverse control time slot by randomly delaying, thereby avoiding signal interference when transmitting the reverse communication data simultaneously.

In a preferred embodiment, the randomly generated delay duration may be an integer multiple of the isochronous intervals, such as randomly delaying 0 to M isochronous intervals, and M is a positive integer. The third select mechanism is to select one or more shared reverse control time slots as the one or more target shared reverse control time slots based on a number of shared reverse control time slots in the one or more target isochronous intervals.

Since the master device can flexibly configure the number of shared reverse control time slots, the slave device can adjust the target shared reverse control time slots accordingly based on the configured number of shared reverse control time slots when selecting the target shared reverse control time slots. For example, when the number of shared reverse control time slots N is 1, each of the shared reverse control time slots in each target isochronous interval may be selected as the target shared reverse control time slot. When N is 4, the first and the third of the shared reverse control time slots may be selected as the target shared reverse control time slots, so as to send the reverse communication data twice in one target isochronous interval, and to improve the success rate of the master device in receiving the reverse communication data.

The fourth mechanism is to select one or more from the shared reverse control time slots in the one or more target isochronous intervals as the one or more target shared reverse control time slots based on a communication quality and/or a response time requirement of the reverse communication.

In one embodiment, the slave device can actively adjust timing and frequency of transmitting the reverse communication data based on the current communication condition. Such active adjustment may be realized by selecting the target shared reverse control time slots. In one specific embodiment, the slave device can detect its own broadcast communication quality. For example, the slave device can assess the current communication quality based on a success rate of receiving BIS PDUs, a signal strength of receiving the BLE audio data broadcast signals or the periodic advertising signals, or a channel quality of the periodic advertising channel. Thereby, the target shared reverse control time slot is selected based on the communication quality. In the case of good communication quality, such as a packet loss rate of the received packets is lower than a predetermined threshold, or the signal strength is higher than a predetermined threshold, or the channel quality is higher than a predetermined threshold, it is considered that the current communication condition is good, and the number of the target shared reverse control time slots may be reduced, and a time domain spacing of the two adjacent target shared reverse control time slots may be increased. Conversely, when the communication condition is poor, the number of target shared reverse control time slots may be increased and the time domain spacing thereof may be decreased, so as to improve the transmission efficiency of the reverse communication data.

In one embodiment, the slave device can also actively adjust the timing and frequency of transmitting the reverse communication data according to the response time requirement of the reverse communication. For example, when performing user-oriented reverse communication comprising the volume control, the lighting pattern control, the media control, the power off control, etc., the number of the target shared reverse control time slots can be increased and their time domain spacing can be reduced, thereby improving the transmission efficiency of the reverse communication, shortening the response time of the master device, and providing a better user experience. When performing non-user-oriented reverse communication comprising the transmit power control, feedback of the version information, etc., the number of the target shared reverse control time slots can be appropriately reduced and their time domain spacing can be increased, so as to reduce the occupancy of the shared reverse control time slots by the present slave device, and improve the transmission efficiency of the reverse communication of other target slave devices.

In the BLE audio broadcasting system provided according to one embodiment of the present invention and the BLE audio broadcasting method applied in the BLE audio broadcasting system, one or more shared reverse control time slots are configured within one target isochronous interval in the periodic advertising communication with reverse control, wherein the shared reverse control time slot can be occupied by any one of the slave devices when transmitting reverse communication data. In the periodic advertising communication with reverse control, the master device does not need to allocate the exclusive time slot for any target slave device, and all the target slave devices that need to perform the reverse communication can occupy the one or more shared reverse control time slots in the one or more target isochronous intervals in order to send the reverse communication data. Thus, the present invention can realize reverse control and bi-directional communication of point-to-multipoint audio broadcast communication when information of the slave devices is uncertain, thereby enhancing controllability of the BLE audio broadcasting system.

The present invention will be further described in detail below in conjunction with a specific application scenario. The following will take Auracast networked party speakers as a specific application scenario. In order to facilitate description and understanding, with reference to a naming convention of the Bluetooth technology system for similar technologies, the periodic advertising communication with reverse control implemented in the BLE audio broadcasting method according to one embodiment of the present invention will be referred to as a Periodic Advertising with Reverse Control (PAWRC) link protocol. The master device and the slave devices establish a reverse control channel through the PAWRC link protocol, which facilitates the slave devices to send control instructions or feedback information, thus improving the controllability of the BLE audio broadcasting system and realizing the power off control, the version control, the transmit power control, the media control, the volume control, or the lighting pattern control.

In the application scenario, the BLE audio broadcasting system (also known as wireless point-to-multipoint audio system) shown in FIG. 1 is the Auracast networked party speakers, which consists of a networked party master speaker and a plurality of networked party slave speakers. The master speaker broadcasts audio data to the slave speakers via the BIG protocol and the PBP protocol. The master speaker and the slave speakers establish a reverse control channel via the PAWRC link protocol to facilitate the transmitting of control instructions from the slave speakers to improve controllability of the networked party speakers.

The master speaker sends the periodic advertising packet in the periodic advertising time slot, and the slave speaker passes the reverse communication data via the reverse communication packet in the shared reverse control time slot. A format of the periodic advertising packet or the reverse communication packet may be set according to a specific application scenario.

As one specific embodiment, in order to be better compatible with the current Bluetooth technology specification, both the periodic advertising packet and the reverse communication packet of the PAWRC link protocol can use AUX_SYNC_IND Protocol Data Unit (PDU) with a modified extended header. In order to distinguish the two, the periodic advertising packet can be named as AUX_SYNC_IND PDU, and the reverse communication packet can be named as AUX_SYNC_RC PDU.

The format of the extended header of AUX_SYNC_IND PDU and/or AUX_SYNC_RC PDU is shown in FIG. 5 schematically. The Reverse Control Flags (RC flags) field and the Reverse Control Slot Number (RC Slot Num) field are added to the existing Bluetooth protocol.

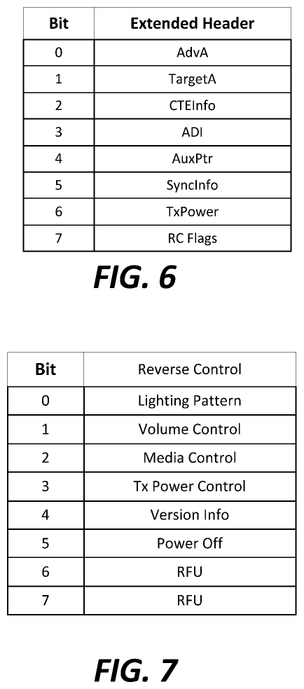

A format of an extended header flags field in the extended header is shown schematically in FIG. 6. A reserved 7th bit of the extended header flags field in the existing Bluetooth protocol is defined as a reverse control flag (RC flags) enable bit. In one embodiment, if one bit of the extended header flags field is set to 1, it indicates that the extended header contains the field corresponding to the one bit of the extended header flags field as shown in FIG. 5. If the 7th bit of the extended header flags field of the AUX_SYNC_IND PDU is set to 1, it indicates that the extended header comprises the RC flags field and the RC Slot Num field. If the 7th Bit of the extended header flags field of AUX_SYNC_RC PDU is set to 1, it indicates that the extended header comprises the RC flags field.

The specific meanings of the other fields of the extended header are as follows: AdvA represents an address of the advertising transmitting device, TargetA represents an address of the target slave device, CTEInfo represents the Constant Tone Extension (CTE) information, ADI represents the advertising data information, AuxPtr represents the Auxiliary Advertising Pointer, SyncInfo represents the synchronization information, TxPower represents the transmit power, and ACAD represents the Additional Controller Advertising Data (ACAD). The ACAD is usually configured to carry BIG information (BIGInfo).

The format of the reverse control flags (RC Flags) field is shown in FIG. 7. Each bit of the RC flags field corresponds to one certain function of reverse control or response. For AUX_SYNC_IND PDU, if one bit of the RC flags field is set to 1, it indicates that the master device instructs the slave device to send the control instruction for corresponding function. For AUX_SYNC_RC PDU, if one bit of the RC flags field is set to 1, it indicates that the slave device sends the control instruction for corresponding function in the Adv Data. For example, 0^{th} Bit indicates the Lighting Pattern, 1^{st} Bit indicates the Volume Control, 2^{nd} Bit indicates the Media Control, 3^{rd} Bit indicates the Tx Power Control, 4^{th} Bit indicates the Version Info, 5^{th} Bit represents the Power Off control, and 6^{th} Bit and 7^{th} Bit are Reserved for Future Use (RFU:).

In some other embodiments, the first flag field and the second flag field are comprised in the advertising data (adv data) of the periodic advertising packet, and the second flag field is comprised in the advertising data (adv data) of the reverse communication packet.

FIG. 2 also illustrates the BIG time slot structure based on the PAWRC link, wherein the box labeled EA represents a time slot for the master device to send the extended advertising protocol packet ADV_EXT_IND PDU on a primary advertising channel, and the box labeled AA represents a time slot for the master device to send the auxiliary advertising protocol packet AUX_ADV_IND PDU on a secondary advertising channel. The box labeled SA represents a time slot for the master device to send the Periodic advertising packet AUX_SYNC_IND PDU carrying the BIGInfo on the periodic advertising channel, and the box labeled BIS PDU represents a time slot for the master device to send the Broadcast Isochronous protocol packet on the Isochronous channel. The box labeled RC represents the time slot for the slave device to send the reverse communication packet AUX_SYNC_RC PDU on the periodic advertising channel.

In one specific embodiment, in the BIG time slot structure based on the PAWRC link as shown in FIG. 5, only the 7^{th} Bit of the extended header flags field in the extended header of the AUX_SYNC_IND PDU is set to 1, and the extended header only comprises the RC flags field carrying the reverse control flag bits, the RC Slot Num field and the ACAD carrying the BIGInfo. Optionally, the 1^{st} Bit of the extended header flags field in the extended header of the AUX_SYNC_IND PDU can be set to 1, so that TargetA indicate that the slave speaker with a specific address is used to send the control command to avoid interference. The 0^{th} Bit and the 7^{th} Bit of the extended header flags field in the extended header of the AUX_SYNC_RC PDU are set to 1, and the extended header only comprises the AdvA field and the RC flags field that carry the reverse control flag bits. AUX_SYNC_IND PDU and AUX_SYNC_RC PDU both carry specific control instructions via the Adv data and are defined by an application layer.

Without loss of generality, according to the BLE Audio protocol, the main parameters of the BIGInfo carried by the AUX_SYNC_IND PDU sent by the master speaker on the periodic advertising channel comprise: ISO Interval=20 ms, BIS Num=1, NSE=6, BN=2, IRC=6, SDU Size=120 bytes, Unframed format and LE 2M PHY are used. After the master speaker enters an audio playback state, the slave speaker first searches for the ADV_EXT_IND PDU sent by the master speaker on the primary advertising channel in order to obtain the AUX_ADV_IND PDU sent by the master speaker on the secondary advertising channel, and then receive the AUX_ADV_IND PDU to obtain the AUX_SYNC_IND PDU sent by the master speaker on the periodic advertising channel to get the BIGInfo, and then receive BIS PDU according to the BIGInfo, and finally decode the audio data in the BIS PDU and play corresponding audio signal.

In the application scenario of the networked party speakers, 0^{th} Bit, 1^{st} Bit, 2^{nd} Bit, 3^{rd} Bit, 4^{th} Bit and 5^{th} Bit of the RC flags field of the AUX_SYNC_IND PDU sent by the master speaker are all set to 1, i.e., the networked party speakers supports the lighting pattern control, the volume control, the media control, the transmit power control, the version control and the power off control through the slave speaker. The RC Slot Num of the AUX_SYNC_IND PDU sent by the master speaker is 1, and it means that the slave speaker has only one chance to send the AUX_SYNC_RC PDU in each isochronous interval. In scenarios with a large number of slave devices, the RC Slot Num can also be set greater than 1.

In the application scenario of the networked party speakers, any one of the slave speakers synchronizing with the master speaker wants to end the networked party and turn off all the networked party speakers, a power off instruction can be input through the user interface of the slave speaker, and the slave speaker receives the power off instruction and sends the AUX_SYNC_RC PDU with the power off instruction to the master speaker. The 0^{th} Bit and the 7^{th} Bit of the extended header flags field of the AUX_SYNC_RC PDU carrying the power off instruction are set to 1. The extended header comprises AdvA of the slave speaker and the RC flags field carrying the reverse control flag bits, wherein the 5^{th} Bit of the RC flags field is set to 1, and it means that the master speaker is requested to execute the power off instruction. After the master speaker receives the power off instruction from the slave speaker, it sends the power off instruction defined specifically by the application layer to all the slave speakers through the Adv Data of the AUX_SYNC_IND PDU, so that any slave speaker can realize the power off reverse control through the PAWRC link.

In the application scenario of the networked party speakers, after any one of the slave speakers is synchronized with the master speaker, if it is found that the master speaker has an inconsistent version of the PBP protocol and is unable to receive or demodulate the audio normally, it can feed back the PBP version information to the master speaker via the AUX_SYNC_RC PDU. The 0^{th} Bit and the 7^{th} Bit of the extended header flags field of the AUX_SYNC_RC PDU carrying the version information are set to 1, and the extended header comprises AdvA of the slave speaker and the RC flags field carrying the inverse control flag bits, wherein the 4^{th} Bit of the RC flags field is set to 1, and it means that the master speaker is informed of its own version information. Upon receiving the PBP version information of the slave speaker, the master speaker may decide whether to change the current PBP version to be compatible with the slave speakers, thereby enabling any slave speaker to realize the PBP version reverse control through the PAWRC link.

In the application scenario of the described networked party speakers, after any slave speaker synchronizes with the master speaker, if it wants to change the lighting pattern of the networked party speakers, it can input the Lighting Pattern instruction through the user interface of the slave speaker. After the slave speaker receives the Lighting Pattern instruction, and then sends the AUX_SYNC_RC PDU with the Lighting Pattern instruction to the master speaker. The 0^{th} Bit and the 7^{th} Bit of the extended header flags field of the AUX_SYNC_RC PDU carrying the Lighting Pattern instruction are set to 1, and the extended header comprises AdvA of the slave speaker and the RC flags field carrying the inverse control flag bits, wherein the 0^{th} Bit of the RC flags field is set to 1, and it means that the master speaker is requested to execute the instruction to change the Lighting Pattern. After the master speaker receives the Lighting Pattern instruction from the slave speaker, it sends the instruction to change the Lighting Pattern specifically defined by the application layer to all the slave speakers through the Adv Data of AUX_SYNC_IND PDU to perform the action of changing the Lighting Pattern, so that any slave speaker can realize the reverse control of Lighting Pattern through the PAWRC link.

In the application scenario of the networked party speakers, any slave speaker synchronized to the master speaker wants to change the volume of the networked party speakers, and a volume control instruction to change the volume is input through the user interface of the slave speaker. The slave speaker receives the volume control instruction and sends the AUX_SYNC_RC PDU carrying the volume control instruction to the master speaker. The 0^{th} Bit and the 7^{th} Bit of the extended header flags field of the AUX_SYNC_RC PDU carrying the volume control instruction are set to 1, and the extended header comprises AdvA of the slave speaker and the RC flags field carrying the inverse control flag bits, wherein the 1^{st} Bit of the RC flags field is set to 1, and it means that the master speaker is requested to change the volume. After the master speaker receives the volume control instruction from the slave speaker, it sends the volume control instruction defined by the application layer to all the slave speakers through the Adv Data of the AUX_SYNC_IND PDU to perform the volume control, so that any slave speaker realizes the reverse control of the volume of the networked party speakers through the PAWRC link.

In the application scenario of the networked party speakers, after any slave speaker synchronizes with the master speaker, if it want to do media control of the networked party speakers, including play, pause, fast-forward, previous song, next song, etc., it can receive one media control instruction through the user interface of the slave speaker. The slave speaker receives the media control instruction, and then sends AUX_SYNC_RC PDUs carrying the Media Control instruction to the master speaker. The 0^{th} Bit and the 7^{th} Bit of the extended header flags field of the AUX_SYNC_RC PDU carrying the media control instruction are set to 1, and the extended header comprises AdvA of the slave speaker and the RC flags field carrying the inverse control flag bits, wherein the 2^{nd} Bit of the RC flags field is set to 1, i.e. it means that the master speaker is requested to execute the Media Control instruction. Upon receiving the Media Control instruction from the slave speaker, the master speaker executes the Media Control, so that any slave speaker realizes the media control of the master speaker over the PAWRC link.

In the application scenario of the described networked party speakers, any slave speaker synchronized to the master speaker wants to do the transmit power control to the master speaker, it can receive the transmit power control instruction through the user interface of the slave speaker. The slave speaker sends the AUX_SYNC_RC PDU carrying the transmit power control instruction to the master speaker. The 0^{th} Bit and the 7^{th} Bit of the extended header flags field of the AUX_SYNC_RC PDU carrying the transmit power control instruction are set to 1, and the extended header comprises AdvA of the slave speaker and the RC flags field carrying the inverse control flag bits, wherein the 3^{rd} Bit of the RC flags field is set to 1, and it means that the master speaker is requested to execute the transmit power control instruction. Upon receiving the transmit Power Control instruction from the slave speaker, the master speaker executes the transmit Power Control so that any slave speaker realizes the reverse control of the transmit power of the master speaker through the PAWRC link.

In the application scenario of the networked party speakers, in order to improve the reliability of the reverse control instruction, optionally, the 1^{st} Bit of the extended header flags filed in the extended header of the AUX_SYNC_IND PDU can also set to 1, the slave speakers with a specific address is designated to send the control instruction through the TargetA to avoid interference. Take the lighting pattern control as an example, the master speaker receives AUX_SYNC_RC PDU carrying the Lighting Pattern instruction from the slave speaker, and although the AdvA and the RC flags filed of the slave device can be recognized, there is an error in the Lighting Pattern data in the Adv Data, and it is necessary for the slave speaker to resend the Lighting Pattern data. The master speaker can send the AUX_SYNC_IND PDU to this specific slave speaker, and the 1^{st} Bit and 7^{th} Bit of the extended header flags field in the extended header are set to 1. The extended header comprises TargetA and the RC flags carrying the reverse control flag bits, wherein only the 0^{th} bit of the RC flags field is set to 1. Only the slave speaker whose address is specified by the TargetA can receive AUX_SYNC_IND PDU and send the AUX_SYNC_RC PDU, so as to avoid interferences. Until the master speaker receives the Lighting Pattern data correctly, then the AUX_SYNC_IND PDU without the TargetA is sent.

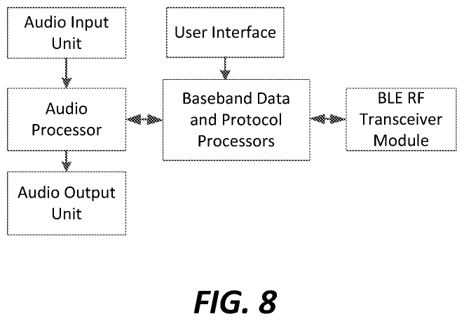

FIG. 8 is a schematic structure diagram of an electronic device according to one embodiment of the present invention. The electronic device may be used as the master device or the master speaker, and may also be used as the slave device or the slave speaker. The electronic device comprises a user interface, a baseband data and protocol processor, and a BLE RF transceiver module. The user interface is configured to receive a reverse communication setup instruction input by a user. The baseband data and protocol processor is configured to perform a BLE audio data broadcast communication in a plurality of consecutive isochronous intervals, and is further configured to perform a periodic advertising communication with reverse control based on a periodic advertising channel within one or more target isochronous intervals.

The BLE radio frequency transceiver module is configured for transmitting and receiving BLE wireless signals. In one specific embodiment, for example, when the electronic device is the master speaker, the electronic device may further comprise an audio input unit and an audio processing unit. The audio input unit is configured for obtaining a digital audio signal and transmitting it to the audio processing unit. The audio processing unit is configured for compressing and encoding the digital audio signal into audio data according to the BLE Audio protocol. The baseband data and protocol processor executes the BLE Audio related BIG and PBP protocols and the PAWRC protocol and processes the audio data into BIS PDUs suitable for transmitting by the BLE RF transceiver module and processes the PAWRC protocol into AUX_SYNC_IND PDUs suitable for transmitting by the BLE RF transceiver module. The BLE RF transceiver module is configured for transmitting and receiving the BLE wireless signals or various PDUs, including transmitting AUX_SYNC_IND PDUs and receiving AUX_SYNC_RC PDUs. The user interface may be a button, a touch screen, a wireless control interface, and the like, and is configured for obtaining instructions such as power off control, transmit power control, media control, volume control, and lighting pattern control.

In one specific embodiment, for example, when the electronic device is the slave speaker, the electronic device may further comprise an audio output unit and an audio processing unit. The baseband data and protocol processor executes the BLE Audio related BIG and PBP protocols and the PAWRC protocol, processes the BIS PDUs received by the BLE RF transceiver module from the master speaker of the networked party speakers and sends them to the audio processing unit. The audio processing unit is configured for post-processing such as audio decoding, packet loss processing, equalization and sound effects. The audio output unit is configured to convert audio signals into sound signals. The BLE RF transceiver module is configured for transmitting and receiving BLE wireless signals or various PDUs, including transmitting AUX_SYNC_RC PDUs and receiving AUX_SYNC_IND PDUs. The user interface may be a button, a touch screen, a wireless control interface, and the like, and is configured for obtaining instructions such as power off control, transmit power control, media control, volume control, and lighting pattern control.

In one embodiment, the present invention also provides a chip. The chip comprises: a processing module and a storage module. The storage module stores instructions that can be executed by the processing module. The instructions being executed by the processing module to enable the processing module to execute the BLE audio broadcasting method in the above embodiments of the present invention. The chip can be applied to the slave device or the master device so as to perform the various methods of the above embodiments and can achieve the same technical effect, which will not be repeated herein in order to avoid repetition.

In one embodiment, the present invention also provides a computer-readable storage medium having a computer program stored thereon. When the computer program is executed by a processor to realize the BLE audio broadcasting method in the above-described embodiment and can achieve the same technical effect, which will not be repeated herein in order to avoid repetition. The computer-readable storage medium can be a read-only memory (ROM), random access memory (RAM), magnetic disc or optical disc, and etc.

The present invention is described with reference to methods, equipment (systems), and flow charts and/or block diagrams of computer program products according to the embodiment of the present invention. It should be understood that each flow and/or block in a flowchart and/or block diagram, as well as the combination of flow and/or block in a flowchart and/or block diagram, can be implemented by computer program instructions. These computer program instructions may be provided to a processor of a general purpose computer, a dedicated computer, an embedded processor, or other programmable data processing device to produce a machine such that instructions executed by a processor of a computer or other programmable data processing device produce instructions for implementing a flow chart or more. A device for processes and/or block diagrams or functions specified in a box or multiple boxes.

These computer program instructions may also be stored in a computer-readable memory that may guide a computer or other programmable data processing device to work in a particular way, such that the instructions stored in the computer-readable memory generate a manufacturer comprising an instruction device that is implemented in a flow chart one or more processes. Process and/or block diagram, a box or function specified in multiple boxes.

These computer program instructions may also be loaded on a computer or other programmable data processing device such that a series of operational operations are performed on a computer or other programmable device to produce computer-implemented processing, thereby providing instructions executed on a computer or other programmable device for implementing a flow chart. The operations of a process or multiple processes and/or block diagrams, or functions specified in a box.

Although preferred embodiments of the present invention have been described, additional changes and modifications to these embodiments may be made once the basic creative concepts are known to those skilled in the art. The appended claims are therefore intended to be interpreted to comprise preferred embodiments and all changes and modifications falling within the scope of this application.

Obviously, a person skilled in the art may make various changes and variations to the application without departing from the spirit and scope of the application. Thus, if these modifications and variations of this application fall within the scope of the claims and their equivalent technologies, the application is also intended to comprise these changes and variations.

What is claimed is:

1. A BLE audio broadcasting method applied to one slave device of a BLE audio broadcasting system comprising a master device and one or more slave devices, the method comprising:
performing a BLE audio data broadcast communication with the master device in a plurality of consecutive isochronous intervals by the slave device; and
performing a periodic advertising communication with reverse control with the master device based on a periodic advertising channel within one or more target isochronous intervals being one or more of the consecutive isochronous intervals, said periodic advertising communication with reverse control comprising:
determining whether the present slave device is a target slave device that requires a reverse communication; and
transmitting a reverse communication data based on the periodic advertising channel in one or more shared reverse control time slots in the one or more target isochronous intervals without need for the master device to allocate an exclusive time slot for the present salve device when the present slave device is determined to be the target slave device, wherein the one or more shared reverse control time slots can be occupied by any one of the slave devices when transmitting the reverse communication data.

2. The BLE audio broadcasting method according to claim 1, wherein said transmitting a reverse communication data based on the periodic advertising channel in one or more shared reverse control time slots in the one or more target isochronous intervals without need for the master device to allocate an exclusive time slot for the present salve device when the present slave device is determined to be the target slave device, comprises:
selecting one or more target shared reverse control time slots among the one or more shared reverse control time slots in the one or more target isochronous intervals based on a predetermined selection mechanism without the need for the master device to allocate the exclusive time slot for the present slave device, wherein the one or more target shared reverse control time slots are configured for the target slave device to transmit the reverse communication data.

3. The BLE audio broadcasting method according to claim 2, wherein the predetermined selection mechanism comprises:
selecting each shared reverse control time slot in one target isochronous interval as the one or more target shared reverse control time slots; or
selecting one or more shared reverse control time slots as the one or more target shared reverse control time slots based on a number of shared reverse control time slots in the one or more target isochronous intervals; or
selecting, based on a randomly generated delay duration, corresponding shared reverse control time slot after delaying the delay duration as the one or more target shared reverse control time slots; or
selecting one or more shared reverse control time slots from the one or more shared reverse control time slots in the one or more target isochronous intervals as the one or more target shared reverse control time slots based on a communication quality and/or a response time requirement of the reverse communication.

4. The BLE audio broadcasting method according to claim 1, wherein a periodic advertising time slot is further configured within one target isochronous interval, the periodic advertising communication with reverse control further comprises:
receiving a reverse communication enabling instruction broadcasted by the master device within the periodic advertising time slot in the target isochronous interval, wherein the reverse communication enabling instruction is configured to indicate that one or more functions of reverse control or response are allowed/prohibited; and
determining whether to transmit the reverse communication data based on the reverse communication enabling instruction when the present slave device is determined to be the target slave device.

5. The BLE audio broadcasting method according to claim 1, wherein a periodic advertising time slot is further configured within one target isochronous interval, the periodic advertising communication with reverse control further comprises:
receiving a number N of shared reverse control time slots broadcasted by the master device within the periodic advertising time slot in the target isochronous interval, wherein N is a positive integer greater than or equal to 1; and
determining a time domain position of each shared reverse control time slot within the target isochronous interval based on the number N of shared reverse control time slots.

6. The BLE audio broadcasting method according to claim 4, wherein the determining whether the present slave device is a target slave device that requires a reverse communication, comprises:
determining whether the present device is the target slave device that requires the reverse communication based on an externally inputted reverse control instruction; or
receiving a target slave device designation instruction broadcasted by the master device within the periodic advertising time slot in the target isochronous interval, determining whether the present device is the target slave device that that requires the reverse communication based on the target slave device designation instruction.

7. The BLE audio broadcasting method according to claim 4, wherein the periodic advertising time slot have a predetermined time domain location within the target isochronous interval;
a first predetermined time period is spaced between a termination time point of the periodic advertising time slot and a start time point of the shared reverse control time slot adjacent to the periodic advertising time slot in the time domain;
a second predetermined time period is spaced between a termination time point of a previous shared reverse control time slot and a start time point of a subsequent shared reverse control time slot in two adjacent shared reverse control time slots when there is a plurality of shared reverse control time slots within one target isochronous interval;
a third predetermined time period is spaced between two adjacent target isochronous time slots in the time domain.

8. The BLE audio broadcasting method according to claim 7, wherein the first predetermined time period and the second predetermined time period are both set as a minimum event space or a minimum data inter-frame space specified by Bluetooth protocol;
the third predetermined time period is set as an integer multiple of the isochronous interval.

9. The BLE audio broadcasting method according to claim 4, wherein the master device is configured for broadcasting a periodic advertising packet within the periodic advertising time slot of the target isochronous interval, and the target slave device is configured for transmitting a reverse communication packet within the shared reverse control time slot,
the periodic advertising packet or the reverse communication packet comprises one or more of following flag fields:
a first flag field configured for the master device to indicate a number N of shared reverse control time slots, N being a positive integer greater than or equal to 1;
a second flag field configured for the master device to indicate a reverse communication enabling instruction which indicates that one or more functions of reverse control or response is allowed/prohibited, or, for the slave device to indicate a reverse communication indication message which indicates that the reverse communication data for one or more functions is carried in the reverse communication packet;
a third flag field configured for indicating an address of the master device;
a fourth flag field configured for the master device to indicate a target slave device designation instruction, or, for the target slave device to indicate an address of this device;
a fifth flag field configured for indicating a constant tone extension information;
a sixth flag field configured for indicating an advertising data information;
a seventh flag field configured for indicating an auxiliary advertising pointer;
an eighth flag field configured for indicating a synchronization information;
a ninth flag field configured for indicating a transmit power;
a tenth flag field configured for indicating an additional controller advertising data ACAD.

10. The BLE audio broadcasting method according to claim 9, wherein bits in the second flag field correspond to the one or more functions respectively;
the one or more functions comprise one or more of lighting pattern control, volume control, media control, transmit power control, version information, and power off control.

11. The BLE audio broadcasting method according to claim 10, wherein the master device and the slave device perform the BLE audio data broadcast communication in a plurality of consecutive isochronous intervals based on a BLE broadcast isochronous channel protocol;
the periodical advertising packet and the reverse communication packet both are Bluetooth protocol data units AUX_SYNC_IND with extended header, the flag fields are configured in a header of the packet; or,
the periodic advertising packet and the reverse communication packet both are Bluetooth protocol data units AUX_SYNC_IND, an advertising data of the periodic advertising packet comprises the first flag field and the second flag field, and an advertising data of the reverse communication packet comprises the second flag field.

12. A BLE audio broadcasting method applied to a master device of a BLE audio broadcasting system comprising the master device and one or more slave devices, comprising:
performing a BLE audio data broadcast communication with the slave devices in a plurality of consecutive isochronous intervals by the master device; and
performing a periodic advertising communication with reverse control with the slave devices based on a periodic advertising channel within one or more target isochronous intervals being one or more of the consecutive isochronous intervals, the periodic advertising communication with reverse control comprising:
receiving a reverse communication data transmitted by a target slave device based on a periodic advertising channel in one or more shared reverse control time slots in the one or more target isochronous intervals without need for the master device to allocate an exclusive time slot for the target salve device, wherein the target slave device is one slave device that requires a reverse communication, the one or more shared reverse control time slots can be occupied by any one of the slave devices when transmitting the reverse communication data.

13. The BLE audio broadcasting method according to claim 12, wherein a periodic advertising time slot is further configured within one target isochronous interval, the periodic advertising communication further comprises:
broadcasting a reverse communication enabling instruction within the periodic advertising time slot of the one or more target isochronous intervals, wherein the reverse communication enabling instruction is configured to indicate that one or more functions of reverse control or response are allowed/prohibited; or
configuring N shared reverse control time slots in the one or more target isochronous intervals and broadcasting a number N of shared reverse control time slots within the periodic advertising time slot of the one or more target isochronous intervals.

14. The BLE audio broadcasting method according to claim 12, wherein the receiving a reverse communication data transmitted by a target slave device based on a periodic advertising channel comprises:
receiving, at least during the reverse communication that allows one or more functions of reverse control or response, in each shared reverse control time slot within each target isochronous interval to obtain the reverse communication data transmitted by the target slave device.

15. The BLE audio broadcasting method according to claim 12, wherein the periodic advertising time slot have a predetermined time domain location within the target isochronous interval;
a first predetermined time period is spaced between a termination time point of the periodic advertising time slot and a start time point of the shared reverse control time slot adjacent to the periodic advertising time slot in the time domain;
a second predetermined time period is spaced between a termination time point of a previous shared reverse control time slot and a start time point of a subsequent shared reverse control time slot in two adjacent shared reverse control time slots when there is a plurality of shared reverse control time slots within one target isochronous interval;
a third predetermined time period is spaced between two adjacent target isochronous time slots in the time domain.

16. The BLE audio broadcasting method according to claim 15, wherein the first predetermined time period and the second predetermined time period are both set as a minimum event space or a minimum data inter-frame space specified by Bluetooth protocol;
the third predetermined time period is set as an integer multiple of the isochronous interval.

17. The BLE audio broadcasting method according to claim 13, wherein the master device is configured for broadcasting a periodic advertising packet within the periodic advertising time slot of the target isochronous interval, and the target slave device is configured for transmitting a reverse communication packet within the shared reverse control time slot,
the periodic advertising packet or the reverse communication packet comprises one or more of following flag fields:
a first flag field configured for the master device to indicate a number N of shared reverse control time slots, N being a positive integer greater than or equal to 1;
a second flag field configured for the master device to indicate a reverse communication enabling instruction which indicates that one or more functions of reverse control or response is allowed/prohibited, or, for the slave device to indicate a reverse communication indication message which indicates that the reverse communication data for one or more functions is carried in the reverse communication packet;
a third flag field configured for indicating an address of the master device;
a fourth flag field configured for a master device to indicate a target slave device designation instruction, or, for the target slave device to indicate an address of this device;
a fifth flag field configured for indicating a constant tone extension information;
a sixth flag field configured for indicating an advertising data information;
a seventh flag field configured for indicating an auxiliary advertising pointer;
an eighth flag field configured for indicating a synchronization information;
a ninth flag field configured for indicating a transmit power;
a tenth flag field configured for indicating an additional controller advertising data ACAD.

18. The BLE audio broadcasting method according to claim 17, wherein bits in the second flag field correspond to the one or more functions respectively;
the one or more functions comprise one or more of lighting pattern control, volume control, media control, transmit power control, version information, and power off control.

19. The BLE audio broadcasting method according to claim 18, wherein the master device and the slave device perform the BLE audio data broadcast communication in a plurality of consecutive isochronous intervals based on a BLE broadcast isochronous channel protocol;
the periodical advertising packet and the reverse communication packet both are Bluetooth protocol data units AUX_SYNC_IND with extended header, the flag fields being configured in a header of the packet; or,
the periodic advertising packet and the reverse communication packet both are Bluetooth protocol data units AUX_SYNC_IND, an advertising data of the periodic advertising packet comprises the first flag field and the second flag field, and an advertising data of the reverse communication packet comprises the second flag field.

20. A Bluetooth audio broadcasting device used as a slave device and configured for:
performing a BLE audio data broadcast communication with a master device of a BLE audio broadcasting system in a plurality of consecutive isochronous intervals;
performing a periodic advertising communication with reverse control with the master device based on a periodic advertising channel within one or more target isochronous intervals being one or more of the consecutive isochronous intervals, the periodic advertising communication with reverse control comprising:
determining whether the present slave device is a target slave device that requires a reverse communication; and
transmitting a reverse communication data based on the periodic advertising channel in one or more shared reverse control time slots in the one or more target isochronous intervals without need for the master device to allocate an exclusive time slot for the present salve device when the present slave device is determined to be the target slave device, wherein the one or more shared reverse control time slots can be occupied by any one of the slave devices when transmitting the reverse communication data.
